(19) United States
(12) Patent Application Publication
(10) Pub. No.: US 2006/0141812 A1
(43) Pub. Date: Jun. 29, 2006

(54) Hot attach & detach application cartridge internally and externally connectable to a computer case

(76) Inventor: Yung-Chao Chih, Taoyuan County (TW)

Correspondence Address: BIRCH STEWART KOLASCH & BIRCH, PO BOX 747, FALLS CHURCH, VA, 22040-0747, US

(21) Appl. No.: 11/023,135

(22) Filed: Dec. 27, 2004

(51) Int. Cl. H01R 12/00

(52) U.S. Cl. 439/64

(57) ABSTRACT

A hot attach & detach application cartridge includes an adapter module for mounting in a bay on a computer case to electrically connect to a motherboard in the computer case, and an application cartridge module for a peripheral apparatus to correspondingly mount therein. The adapter module and the application cartridge module are provided with at least two sets of corresponding male and female hot attach & detach connectors, respectively, for transmission of data, and one of the at least two sets of male and female connectors provides faster transmission speed than other sets. The application cartridge module may be externally connected to the motherboard via a cable and the adapter module, or directly located in the bay to internally connect to the motherboard via the adapter module in the bay and a flat cable, so as to achieve the function of hot attach& detach.

### FIELD OF THE INVENTION

The present invention relates to a hot attach & detach application cartridge, and more particularly to a hot attach & detach application cartridge that may be externally connected to a motherboard in a computer case via a cable and an adapter module mounted in a bay on the computer case, or located in the bay to internally connected to the motherboard via the adapter module and a flat cable.

### BACKGROUND OF THE INVENTION

In response to the prosperous developments in the information industrial fields and the wide application of computers in recent years, various kinds of peripherals have been developed and introduced into the market. Particularly, the electronic industry has quickly entered the multimedia era, and a huge amount of audio-visual data is accessed at high speed. To enable many portable peripherals to be plug and play, manufacturers in the related industrial fields have researched and developed many other application interfaces other than USB, such as 1394, SATA, etc., or even SAS that is designed for use with hosts of servers. These new application interfaces have higher transmission speed than the general USB interface and provide the function of hot attach & detach, and could be used with hot attach & detach connectors to enable plug and play of the peripherals.

Most of the currently commercially available desktop or notebook computers include a computer case having sockets for USB or 1394 connectors provided on a panel of the computer case, so that peripherals may be connected to other components in the computer case via flat cables. SATA and SAS connectors are hot attach & detach connectors providing even faster transmission speed than USB connectors, and are typically used on computers and servers of new generation. Since the super-high transmission speed of SATA and SAS is restricted by the length of the connecting flat cable thereof, it is undesirable to use a long flat cable when a high-speed transmission is desired. That is why sockets for SATA and SAS connectors are not provided on the panel of the computer case.

Moreover, peripherals with SATA and SAS hot attach & detach connectors usually have sizes only suitable for use in bays on an initial corresponding computer case but not bays on other computers. It is therefore apparently the SATA and SAS connectors are not ideal for external connection of the peripherals to computers.

It is therefore tried by the inventor to develop a hot attach & detach application cartridge that may be either externally connected to a motherboard in a computer case via a cable and an adapter module mounted in a bay on the computer case, or located in the bay to internally connect to the motherboard via the adapter module and a flat cable.

### SUMMARY OF THE INVENTION

A primary object of the present invention is to provide a hot attach & detach application cartridge internally and externally connectable to a computer case. To achieve the above and other objects, the application cartridge of the present invention mainly includes an adapter module for mounting in a bay on the computer case to electrically connect to a motherboard in the computer case via a flat cable, and an application cartridge module for a peripheral apparatus to correspondingly mount therein and adapted to locate in the bay on the computer case having the adapter module mounted therein. The adapter module and the application cartridge module are provided with at least two sets of corresponding male and female hot attach & detach connectors, respectively, for transmission of data, and one of the at least two sets of male and female connectors provides faster transmission speed than other sets. The application cartridge module may be externally connected to the motherboard via a cable and the adapter module mounted in the bay, or directly located in the bay to internally connect to the motherboard via the adapter module and the flat cable, so as to achieve the function of hot attach & detach.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a hot attach & detach application cartridge of the present invention for internally and externally connecting to a computer case;

FIG. 2 shows the manner of assembling the application cartridge of FIG. 1 to the computer case;

FIG. 3 shows a first preferred embodiment of the present invention for internally connecting to a computer case; and

FIG. 4 shows a second preferred embodiment of the present invention for externally connecting to a computer case.

### DETAILED DESCRIPTION OF THE PREFERRED EMBODIMENTS

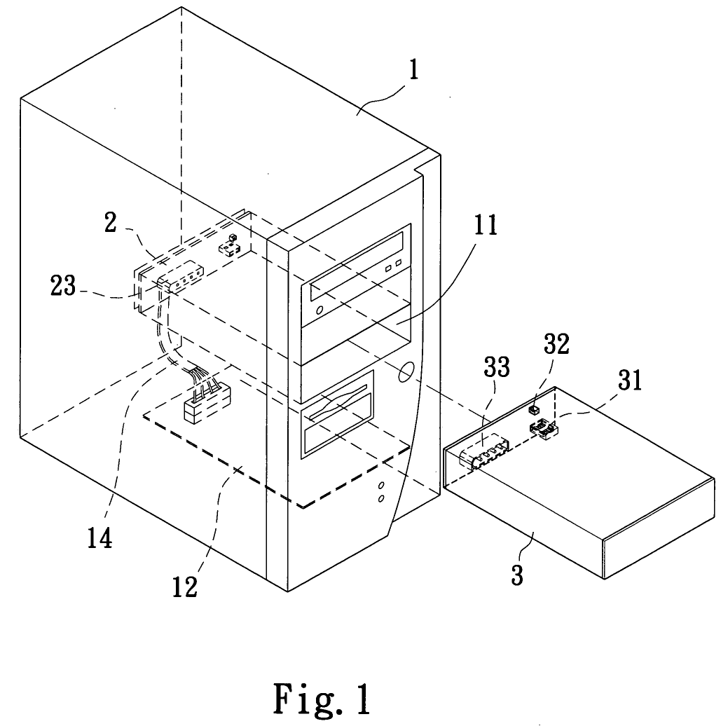

Please refer to FIG. 1 that is an exploded perspective view of a hot attach & detach application cartridge of the present invention internally and externally connectable to a computer case. As shown, the hot attach & detach application cartridge mainly includes an adapter module 2 for mounting in a bay 11 on a computer case 1 to electrically connect to a motherboard 12 in the computer case 1, and an application cartridge module 3 for a peripheral apparatus (not shown) to correspondingly mount therein. In a preferred embodiment of the present invention, the application cartridge module 3 is adapted to locate in the bay 11. The adapter module 2 is provided with one or more USB, 1394, and SATA male connectors 21, 22, 23; and the application cartridge module 3 is correspondingly provided with one or more USB, 1394, and SATA female connectors 31, 32, 33. However, it is understood the number of the male and female connectors provided on the adapter module 2 and the application cartridge module 3 is not limited to the above-mentioned three, and the types of the male and female connectors provided on the two modules 2, 3 may be otherwise USB, SAS, and SATA connectors, or USB, 1394, and SAS connectors, or 1394, SAS, and SATA connectors.

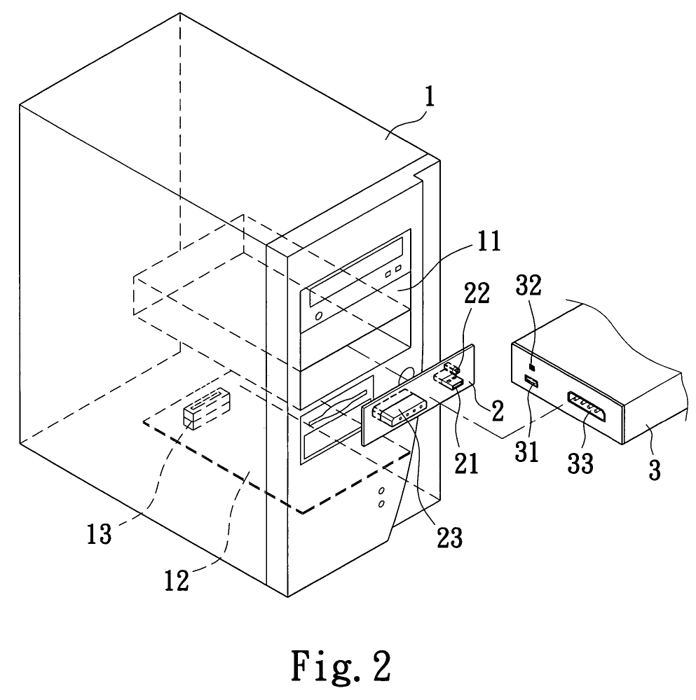

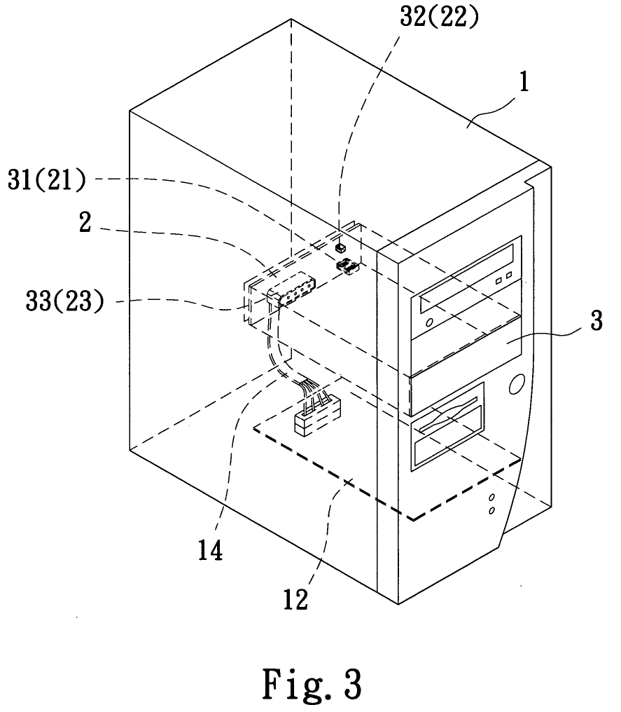

Please refer to FIG. 2. The adapter module 2 is fixedly mounted in the bay 11 of the computer case 1 with the SATA male connector 23 or a SAS male connector on the adapter module 2 electrically connected to a SATA female connector 13 or a SAS female connector, respectively, on the motherboard 12 in the computer case 1 via a flat cable 14. And, in a first preferred embodiment of the present invention, the application cartridge module 3 is positioned in the same one bay 11 with the SATA female connector 33 or a SAS female connector directly aligned with and connected to the SATA male connector 23 or the SAS male connector on the adapter module 2, as shown in FIG. 3.

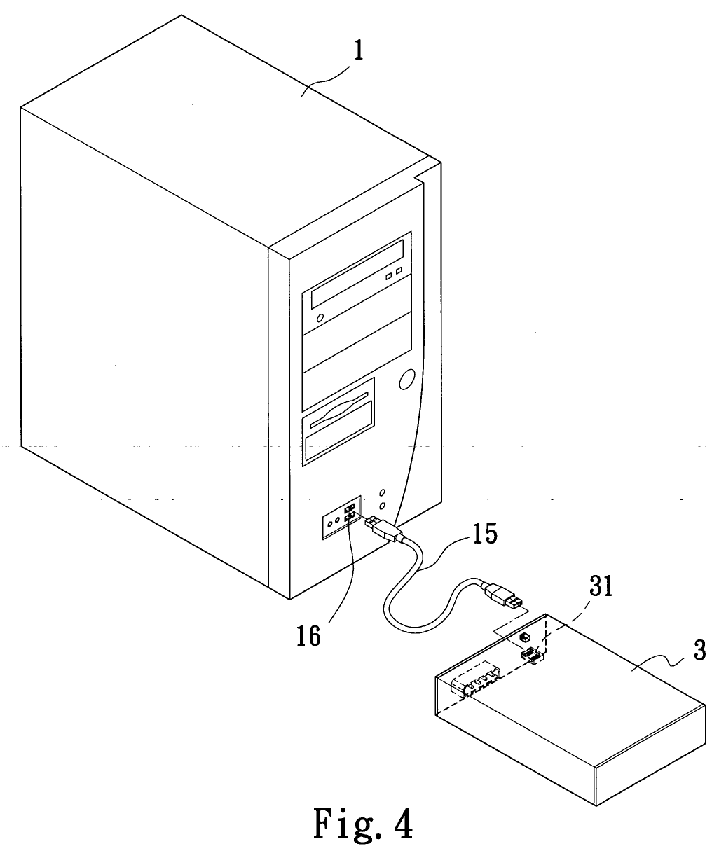

In case there is not a bay 11 on the computer case 1 available or suitable for the application cartridge module 3, it is possible to connect the application cartridge module 3 to the motherboard 12 in the computer case 1 by connecting the USB female connector 31 on the application cartridge module 3 to a USB connector 16 provided on a panel of the computer case 1 via a cable 15, as shown in FIG. 4.

With the above arrangements, the application cartridge module 3 may be externally connected to the computer case 1 via the cable 15, or internally connected to the computer case 1 by positioning the application cartridge module 3 in one bay 11 on the computer case 1 to connect to the motherboard 12 via the adapter module 2 and the flat cable 14. In either case, the application cartridge module 3 is conveniently connectable to the computer case 1 in the manner of hot attach & detach.

The present invention has been described with some preferred embodiments thereof and it is understood that many changes and modifications in the described embodiments can be carried out without departing from the scope and the spirit of the invention that is intended to be limited only by the appended claims.

1. A hot attach & detach application cartridge internally and externally connectable to a computer case, comprising
an adapter module for mounting in a bay on the computer case to electrically connect to a motherboard in the computer case, and
an application cartridge module for a peripheral apparatus to correspondingly mount therein and adapted to locate in said bay on the computer case having said adapter module mounted therein;
wherein said adapter module and said application cartridge module are provided with at least two sets of corresponding male and female hot attach & detach connectors, respectively, to enable transmission of data between said application cartridge module and said motherboard in said computer case, and one of said at least two sets of male and female connectors providing faster transmission speed than other sets;
wherein said at least two sets of male and female hot attach & detach connectors include at least two different sets selecting from USB, SATA 1394 and SAS male and female hot attach & detach connectors.

2. The hot attach & detach application cartridge internally and externally connectable to a computer case as claimed in claim 1, wherein said at least two sets of male and female hot attach & detach connectors provided on said adapter module and said application cartridge module, respectively, are USB and SATA male and female hot attach & detach connectors.

3. The hot attach & detach application cartridge internally and externally connectable to a computer case as claimed in claim 1, wherein said at least two sets of male and female hot attach & detach connectors provided on said adapter module and said application cartridge module, respectively, are USB and 1394 male and female hot attach & detach connectors.

4. The hot attach & detach application cartridge internally and externally connectable to a computer case as claimed in claim 1, wherein said at least two sets of male and female hot attach & detach connectors provided on said adapter module and said application cartridge module, respectively, are 1394 and SATA male and female hot attach & detach connectors.

5. The hot attach & detach application cartridge internally and externally connectable to a computer case as claimed in claim 1, wherein said at least two sets of male and female hot attach & detach connectors provided on said adapter module and said application cartridge module, respectively, are USB and SAS male and female hot attach & detach connectors.

6. The hot attach & detach application cartridge internally and externally connectable to a computer case as claimed in claim 1, wherein said at least two sets of male and female hot attach & detach connectors provided on said adapter module and said application cartridge module, respectively, are 1394 and SAS male and female hot attach & detach connectors.

7. The hot attach & detach application cartridge internally and externally connectable to a computer case as claimed in claim 1, wherein said at least two sets of male and female hot attach & detach connectors provided on said adapter module and said application cartridge module, respectively, are SATA and SAS male and female hot attach & detach connectors.

8. The hot attach & detach application cartridge internally and externally connectable to a computer case as claimed in claim 1, wherein said at least two sets of male and female hot attach & detach connectors provided on said adapter module and said application cartridge module, respectively, are USB, 1394, and SAS male and female hot attach & detach connectors.

9. The hot attach & detach application cartridge internally and externally connectable to a computer case as claimed in claim 1, wherein said at least two sets of male and female hot attach & detach connectors provided on said adapter module and said application cartridge module, respectively, are USB, 1394, and SATA male and female hot attach & detach connectors.

10. The hot attach & detach application cartridge internally and externally connectable to a computer case as claimed in claim 1, wherein said at least two sets of male and female hot attach & detach connectors provided on said adapter module and said application cartridge module, respectively, are USB, SATA, and SAS male and female hot attach & detach connectors.

11. The hot attach & detach application cartridge internally and externally connectable to a computer case as claimed in claim 1, wherein ;said at least two sets of male and female hot attach & detach connectors provided on said adapter module and said application cartridge module, respectively, are 1394, SATA, and SAS male and female hot attach & detach connectors.

12. The hot attach & detach application cartridge internally and externally connectable to a computer case as claimed in claim 1, wherein said at least two sets of male and female hot attach & detach connectors provided on said adapter module and said application cartridge module, respectively, are USB, 1394, SATA, and SAS male and female hot attach & detach connectors.
